(19) United States
(12) Patent Application Publication
(10) Pub. No.: US 2012/0136919 A1
(43) Pub. Date: May 31, 2012

(54) METHOD AND SYSTEM FOR EDITING MULTIMEDIA FILE

(75) Inventors: Yan-Zhang Huang, Taipei County (TW); Ju-Hung Hsiao, Tainan City (TW); Wei Wang, Xinbei City (TW)

(73) Assignee: GEMTEK TECHNOLOGY CO., LTD., Hsinchu (TW)

(21) Appl. No.: 13/018,338

(22) Filed: Jan. 31, 2011

(30) Foreign Application Priority Data
Nov. 30, 2010 (TW) 99141523

(51) Int. Cl. G06F 15/16

(52) U.S. Cl. 709/203

(57) ABSTRACT

A method and a system for editing a multimedia file are provided, wherein the multimedia file provided by a server is edited and played by a client device. In the present method, the multimedia file provided by the server is downloaded and played. At least one edit operation for modifying the multimedia file is received. The edit operation is converted into a plurality of edit commands recognizable to the server. The edit commands are sent to the server to request the server to modify the multimedia file accordingly. The modified multimedia file is downloaded from the server and played again.

### CROSS-REFERENCE TO RELATED APPLICATION

This application claims the priority benefit of Taiwan application serial no. 99141523, filed on Nov. 30, 2010. The entirety of the above-mentioned patent application is hereby incorporated by reference herein and made a part of this specification.

### BACKGROUND OF THE INVENTION

1. Field of the Invention

The present invention generally relates to a method and a system for editing a file, and more particularly, to a method and a system for editing a multimedia file.

2. Description of Related Art

The digital living network alliance (DLNA) provides a set of industrial standards based on the universal plug and play (UPnP) technology, wherein digital multimedia contents are integrated so that multimedia files (for example, pictures, music, videos, and playlists, etc) can be conveniently shared between DLNA certified devices.

DLNA certified devices include digital media servers (DMS), digital media players (DMP), digital media controllers (DMC), and digital media renderers (DMR). For example, a DMS sends a description file of a multimedia file to a DMP or a DMC to play the multimedia file through the DMP or play the multimedia file on a DMR through the DMC. Because aforementioned devices communicate with each other in a common language and through a common channel, multimedia data can be shared between these devices without installing any additional driver or using any special cable.

According to the existing DLNA specification, a user can read multimedia files from a DMS by using a DMP so that the multimedia files (for example, pictures, music, videos, and playlists, etc) can be shared conveniently. Or, the user can upload or download multimedia files by using a DMP, so as to copy the multimedia files to a DMS or another DMP.

However, a DMP cannot edit or modify the content of any multimedia file in every situation described above, and simply reading and copying multimedia files cannot satisfy the user's requirements. Thereby, a DMP should be equipped with the function of editing and modifying the content of a multimedia file in order to perfect the functionality of a DLNA system.

### SUMMARY OF THE INVENTION

Accordingly, the invention is directed to a method and a system for editing a multimedia file, wherein the multimedia file is edited by using a player of a digital living network alliance (DLNA) system.

The invention provides a multimedia file edit method, wherein a multimedia file provided by a server is edited and played by a client device. In the multimedia file edit method, the multimedia file provided by the server is first downloaded and played. Then, at least one edit operation for modifying the multimedia file is received, and the edit operation is converted into a plurality of edit commands recognizable to the server. Next, the edit commands are sent to the server to request the server to modify the multimedia file accordingly. Eventually, the modified multimedia file is downloaded from the server and played again.

According to an embodiment of the invention, before the step of converting the edit operation into the edit commands recognizable to the server, the multimedia file edit method further includes defining an identification code and an edit code of each of the edit commands, wherein the identification code indicates the multimedia file to be edited, and the edit code indicates the edit operation to be executed.

According to an embodiment of the invention, the step of defining the identification code and the edit code of each of the edit commands further includes defining a new file code of the edit command, wherein the new file code indicates whether a new multimedia file is generated to overwrite the original multimedia file after the edit command is executed.

According to an embodiment of the invention, after the step of sending the edit commands to the server to request the server to modify the multimedia file accordingly, the multimedia file edit method further includes sending an administration command to the server to inquire whether the server has finished executing the edit commands, and when the server has finished executing the edit commands, the multimedia file edit method further includes downloading the modified multimedia file from the server and playing the modified multimedia file again.

According to an embodiment of the invention, the step of downloading and playing the multimedia file provided by the server includes controlling a digital media renderer (DMR) to download and play the multimedia file provided by the server by using a digital media controller (DMC) of the client device.

According to an embodiment of the invention, the step of sending the edit commands to the server to request the server to modify the multimedia file accordingly includes controlling the DMR to send the edit commands to the server by using the DMC of the client device, so as to request the server to modify the multimedia file accordingly.

According to an embodiment of the invention, the step of downloading the modified multimedia file from the server and playing the modified multimedia file again includes controlling the DMR to download and play the modified multimedia file from the server again by using the DMC of the client device.

The invention provides a multimedia file edit system including a server and a client device. The server stores a plurality of multimedia files and provides one of the multimedia files according to a play request corresponding to the multimedia file. The client device includes a network unit, a play unit, an input unit, and a conversion unit. The network unit is connected to the server via a network. The play unit sends the play request to the server via the network to download and play the multimedia file provided by the server. The input unit receives at least one edit operation for modifying the multimedia file. The conversion unit converts the edit operation into a plurality of edit commands recognizable to the server. Herein the edit commands are sent to the server via the network to request the server to modify the multimedia file accordingly. The play unit downloads and plays the modified multimedia file from the server again via the network.

According to an embodiment of the invention, the conversion unit further defines an identification code and an edit code of each of the edit commands, wherein the identification code indicates the multimedia file to be edited, and the edit code indicates the edit operation to be executed.

According to an embodiment of the invention, the conversion unit further defines a new file code of each of the edit commands, wherein the new file code indicates whether to generate a new multimedia file to overwrite the original multimedia file after the edit command is executed.

According to an embodiment of the invention, the play unit further sends an administration command to the server via the network to inquire the server whether the execution of the edit commands is finished, and when the server has finished executing the edit commands, the play unit downloads and plays the modified multimedia file from the server again.

According to an embodiment of the invention, the client device includes a digital media player (DMP) and a DMC, wherein the DMP is configured to play the multimedia file, and the DMC is configured to control a DMR to download and play the multimedia file provided by the server.

According to an embodiment of the invention, the DMC is further configured to control the DMR to send the edit commands to the server, so as to request the server to modify the multimedia file accordingly.

According to an embodiment of the invention, the DMC is further configured to control the DMR to download and play the modified multimedia file from the server again.

According to an embodiment of the invention, the edit commands instruct the server to perform resizing, rotating, brightness adjustment, chromatic aberration adjustment, image processing, or image clipping on the multimedia file.

According to an embodiment of the invention, the server is a digital media server (DMS) in a DLNA system, and the client device is a DMP or a DMC in the DLNA system.

As described above, in the method and the system for editing a multimedia file provided by the invention, an edit operation of a user performed on a multimedia file is converted into edit commands recognizable to a server, and the edit commands are sent to the server to instruct the server to modify the multimedia file. Thereby, a DMP in a DLNA system is allowed to edit the multimedia file.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a multimedia file edit system according to a first embodiment of the invention.

FIG. 2 is a flowchart of a multimedia file edit method according to an embodiment of the invention.

FIG. 3 illustrates an edit code mapping table according to an embodiment of the invention.

FIG. 4 illustrates an example of an edit command according to an embodiment of the invention.

FIG. 5 illustrates an administration code mapping table according to an embodiment of the invention.

FIG. 6 illustrates a format code mapping table according to an embodiment of the invention.

FIG. 7 illustrates an example of a file conversion command according to an embodiment of the invention.

FIG. 8 is a block diagram of a multimedia file edit system according to an embodiment of the invention.

FIG. 9 is a flowchart of a multimedia file edit method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention provides a sharing concept different from that of a digital living network alliance (DLNA) system, wherein a DLNA certified digital media player (DMP) is allowed to offer a multimedia file edit function, and a user can modify the content of a multimedia file according to the actual requirement and share the multimedia file with other users. Thereby, the purpose of multimedia file administration is accomplished.

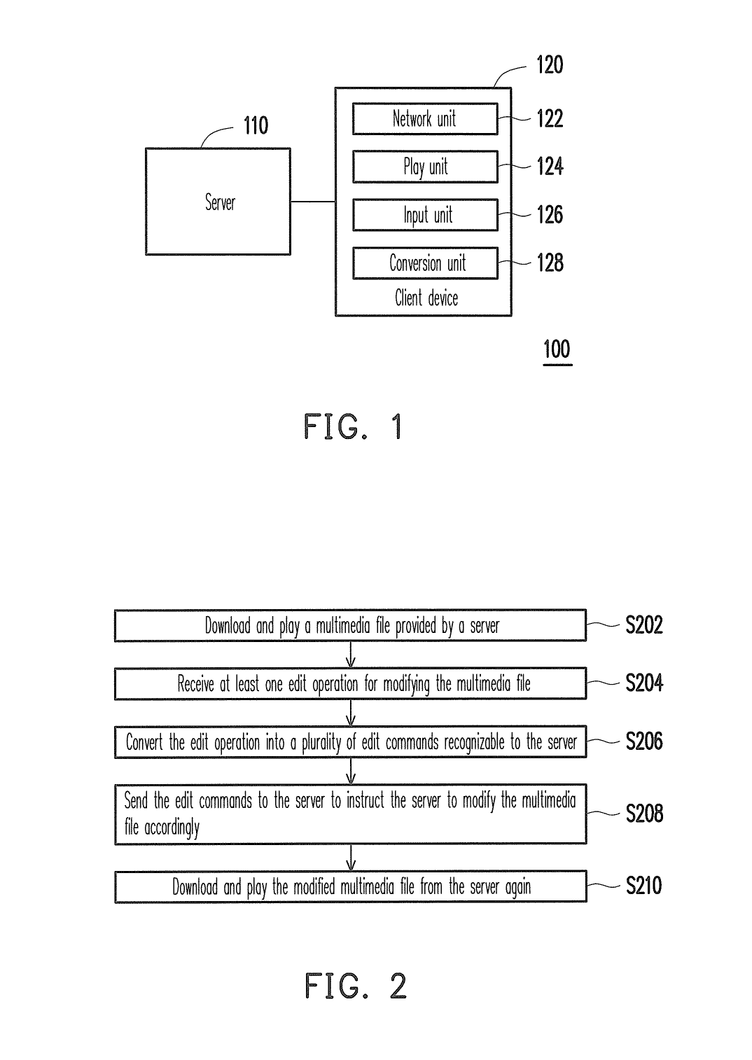

FIG. 1 is a block diagram of a multimedia file edit system according to a first embodiment of the invention. Referring to FIG. 1, the multimedia file edit system 100 in the present embodiment may be a DLNA system, and which includes a server 110 and a client device 120. The functions of the server 110 and the client device 120 will be respectively explained below.

The server 110 may be a DLNA certified digital media server (DMS). The server 110 includes any type of fixed or mobile random access memory (RAM), read-only memory (ROM), flash memory, hard disk, or similar device, and which stores a plurality of multimedia files, wherein the multimedia files include image files, audio files, and video files. The server 110 searches for a multimedia file stored therein according to a play request received from the client device 120 and provides the multimedia file to the client device 120 to be played.

The client device 120 may be a DLNA certified DMP, a digital media controller (DMC), a mobile DMP (MDMP), a mobile DMC (MDMC), or a player and a controller having similar functions. The client device 120 includes a network unit 122, a play unit 124, an input unit 126, and a conversion unit 128. The network unit 122 is connected to the server 110 via a network. The play unit 124 is configured to send a play request to the server 110 via the network so as to download and play a multimedia file. The input unit 126 may be a mouse, a keyboard, or a remote controller, and which is configured to receive an edit operation performed by a user on the multimedia file. The conversion unit 128 is configured to convert the edit operation into a plurality of edit commands recognizable to the server 110. Foregoing edit commands are sent to the server 110 via the network so as to instruct the server 110 to modify the multimedia file accordingly. After the server 110 finishes modifying the multimedia file, the play unit 124 downloads the modified multimedia file from the server 110 via the network and plays the modified multimedia file again.

It should be noted that in the present embodiment, the server 110 offers a multimedia file edit function corresponding to the edit commands issued by the client device 120, and based on the specification of the DLNA system, the server 110 may be a DMP or a DMC. The invention provides a multimedia file edit method corresponding to each of the two types of servers, and below, the multimedia file edit methods will be respectively described in detail with reference to an embodiment.

FIG. 2 is a flowchart of a multimedia file edit method according to an embodiment of the invention. Referring to FIG. 2, the multimedia file edit method in the present embodiment is applicable to the multimedia file edit system 100 illustrated in FIG. 1, wherein the client device 120 is a DMP, and which downloads a multimedia file from the server 110 and plays the multimedia file in an external display. Below, the multimedia file edit method of the present embodiment will be described in detail with reference to FIG. 1.

First, the client device 120 is connected to the server 110 by the network unit 122 via a network, and the play unit 124 sends a play request to the server 110 via the network so as to download and play a multimedia file provided by the server 110 (step S202). Herein before sending the play request, the client device 120 may first inquire the server 110 whether it supports the multimedia file edit function or to what extent it supports such a function, so as to determine whether an edit operation executed by a user can be accepted by the server 110.

Then, the input unit 126 receives at least one edit operation for modifying the multimedia file from the user (step S204), and the conversion unit 128 converts the edit operations into a plurality of edit commands recognizable to the server 110 (step S206). In the present embodiment, many commands are added to the DLNA protocol, and when the user edits an image, a music, or a video on a DMP, the DMP converts the operations of the user into a set of edit commands recognizable to the server 110 and provides the set of edit commands to the server 110 to be executed.

To be specific, the conversion unit 128 defines an identification code and an edit code for each of the edit commands, wherein the identification code indicates the multimedia file to be edited, and the edit code indicates the edit operation to be executed. In addition, the conversion unit 128 defines a new file code for each of the edit commands, wherein the new file code indicates whether to generate a new multimedia file to overwrite the original multimedia file after the edit commands are executed. Herein the edit codes of the edit commands indicate a plurality of edit functions performed by the server 110 on the multimedia file.

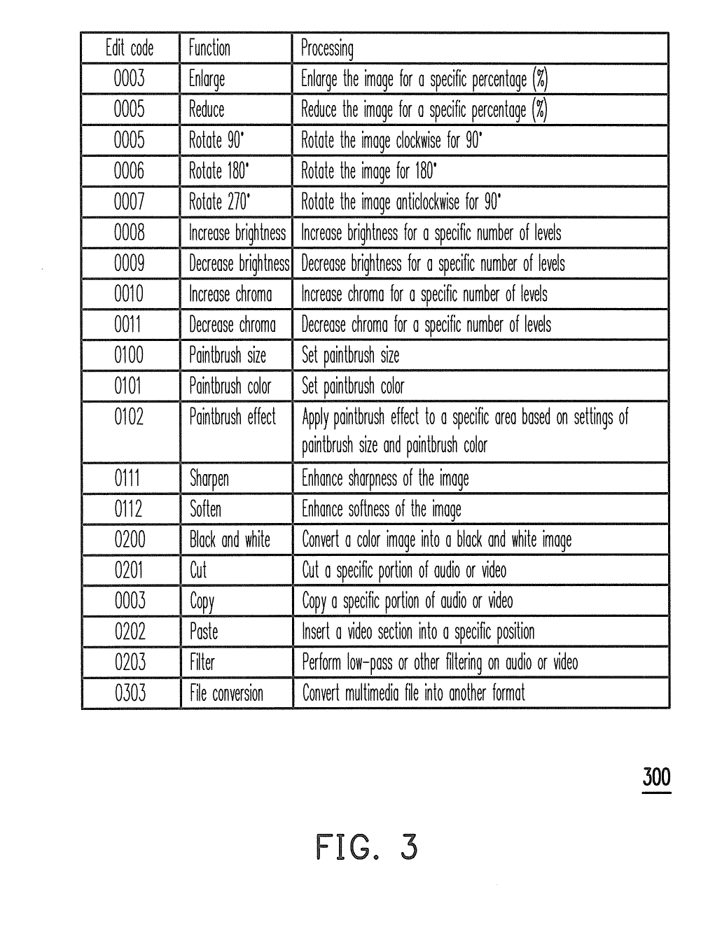

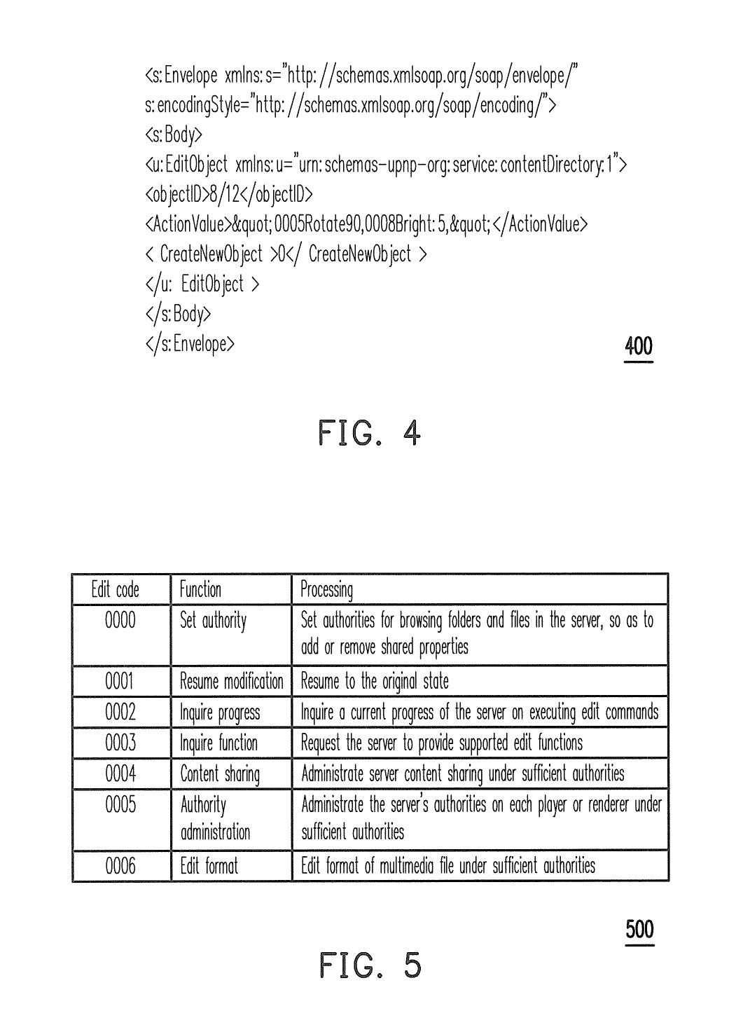

FIG. 3 illustrates an edit code mapping table according to an embodiment of the invention. Referring to FIG. 3, the mapping table 300 in the present embodiment sequentially lists the resizing, rotating, brightness adjustment, chromatic aberration adjustment, image processing, and image clipping functions corresponding to edit codes 0003-0303. FIG. 4 illustrates an example of an edit command according to an embodiment of the invention. Referring to FIG. 4, in the edit command 400 of the present embodiment, the identification code (i.e., the object ID) of the multimedia file is set to an image file named 8/12, the edit code (i.e., the action value) thereof is set to 0005 corresponding to clockwise rotation of 90° and 0008 corresponding to brightness increment of 5 degrees, and the new file code (i.e., the CreatNewObject) thereof is set to 0 (indicating that the original image file is overwritten by a modified image file).

In an embodiment, when a user views an image on a DMS by using a DMP, if the user wants to rotate the image for 90°, sharpen the image, increase the brightness of the image, adjust the color of the paintbrush, or change the color of a specific area, the DMP first displays the corresponding modified image effect on the display. Accordingly, the user can see the edit result on the display and determine whether to keep the current edit result or resume the original state of the image.

In another embodiment, when a user plays music on a DMS by using a DMP, if the user wants to delete a portion of the music and copy another piece of music, the DMP first plays the corresponding modified music effect. Accordingly, the user can hear the edit result and determine whether to keep the current edit result or resume the music to the original state.

The edit commands converted by the conversion unit 128 are sent to the server 110 via the network, so as to instruct the server 110 to modify the multimedia file accordingly (step S208). Herein after the server 110 receives the edit commands, it finds the corresponding multimedia file stored therein according to the identification codes of the edit commands and executes corresponding edit operations on the multimedia file according to the edit codes of the edit commands.

After the server 110 finishes executing the edit commands, the play unit 124 downloads the modified multimedia file from the server 110 and plays the modified multimedia file again (step S210). To be specific, the play unit 124 sends an administration command to the server 110 to inquire whether the server 110 has finished executing the edit commands, and if it determines that the edit commands have been executed, the play unit 124 downloads and plays the modified multimedia file from the server 110 again. Herein the play unit 124 may send an administration command to the server 110 to inquire whether the server 110 has finished executing the edit commands at regular intervals until the execution of the edit commands is completed. After that, the play unit 124 downloads and plays the modified multimedia file from the server 110 again.

To be specific, in order to administrate the content of a multimedia file, in the present embodiment, an administration command is added to the DLNA protocol. The administration command may contain an identification code and an administration code, wherein the identification code indicates the multimedia file to be edited, and the administration code indicates the administration operation to be executed.

FIG. 5 illustrates an administration code mapping table according to an embodiment of the invention. Referring to FIG. 5, the mapping table 500 in the present embodiment sequentially lists the administration operations corresponding to different administration codes, wherein the administration code 0000 represents assigning authority for browsing folders and files on the DMS, adding a shared property, or removing a shared property. The administration code 0001 represents cancelling a previous edit operation to restore the multimedia file to its original state. The administration code 0002 represents inquiring the DMS whether it has finished the editing operation, so as to determine whether to synchronize a multimedia file again and play the modified multimedia file. The administration code 0003 requests a DMS to respond the types of edit operations it supports so that a user can edit a multimedia file accordingly. The administration code 0004 represents the administration of server content sharing under sufficient authorities. The administration code 0005 represents the administration of server's authority on each player or renderer under sufficient authorities. The administration code 0006 represents editing the format of a multimedia file under sufficient authorities. Through foregoing administration commands, a user can perform different administration operations (for example, authority setting, cancelling a previous modification, inquiring whether the execution of the edit command is finished, and administrating the sharing of multimedia files in the server) at any time according to the actual requirements.

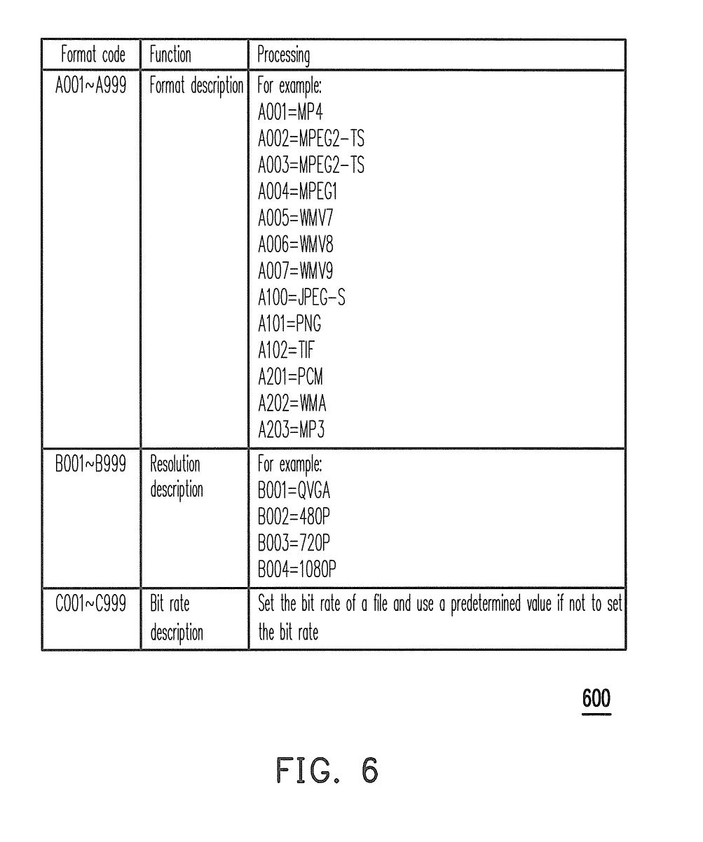

In an embodiment, when the DMS supports conversion of multimedia files, the DMP can request the DMS to convert a multimedia file (for example, an image, a music, a video, or a playlist). To be specific, the DMP adds the edit code 0303 in FIG. 3 and the format code in FIG. 6 into the edit commands to be sent to the DMS, so as to instruct the DMS to convert the multimedia file. Herein the format codes A001-A999 in FIG. 6 represent formats, the format codes B001-B999 represent resolutions, and the format codes C001-C999 represent bit rates.

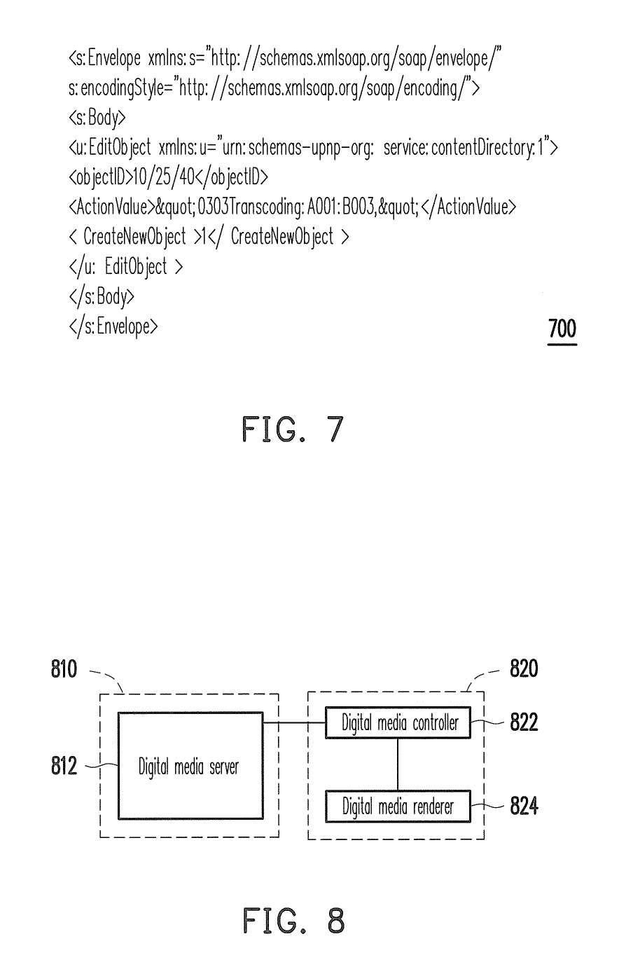

FIG. 7 illustrates an example of an edit command according to an embodiment of the invention. Referring to FIG. 7, in the edit command 700 of the present embodiment, the identification code (i.e., the object ID) of the multimedia file is set to an image file named 10/25/40, the edit code thereof is set to 0303 corresponding to the file conversion function, the format code thereof is set to A001 corresponding to the MP4 format and B003 corresponding to the resolution of 720P, and the new file code (i.e., the CreatNewObject) thereof is set to 1 (indicating not to overwrite the original image file).

It should be noted that in another embodiment, the client device may further be classified into a DMC or a digital media render (DMR), wherein the DMC controls the DMR to download and play the multimedia file provided by the sever. This will be described below in detail with reference to another embodiment.

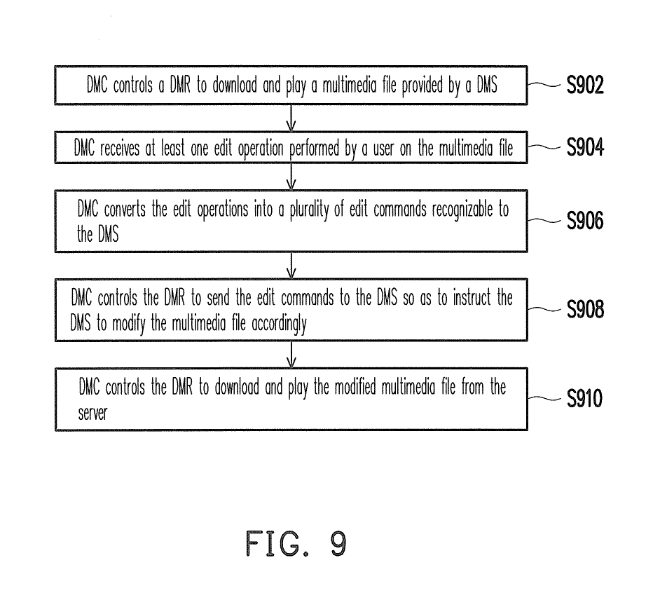

FIG. 8 is a block diagram of a multimedia file edit system according to an embodiment of the invention. FIG. 9 is a flowchart of a multimedia file edit method according to an embodiment of the invention. Referring to FIG. 8 first, in the present embodiment, the multimedia file edit system 800 includes a server 810 and a client device 820, wherein the server 810 is a DMS 812, and the client device 820 includes a DMC 822 and a DMR 824. Below, the multimedia file edit method in the present embodiment will be described in detail with reference to FIG. 8.

First, the DMC 822 controls the DMR 824 to download and play a multimedia file provided by the server 810 (step S902). Then, the DMC 822 receives at least one edit operation performed by a user on the multimedia file (step S904) and converts the edit operations into a plurality of edit commands recognizable to the server 810 (step S906).

Next, the DMC 822 controls the DMR 824 to send the edit commands to the server 810 so as to instruct the server 810 to modify the multimedia file accordingly (step S908). Namely, the DMC 822 sends the edit commands to the DMR 824, and the DMR 824 relays the edit commands to the server 810, so as to instruct the server 810 to modify the multimedia file. It should be noted that in another embodiment, the relaying of the DMR 824 may be omitted and the DMC 822 itself may directly send the edit commands to the server 810 to achieve the same purpose of instructing the server 810 to modify the multimedia file.

Finally, the DMC 822 controls the DMR 824 to download the modified multimedia file from the server 810 and play it again (step S910). To be specific, the DMC 822 sends an administration command to the DMR 824, and the DMR 824 relays the administration command to the server 810 to inquire the server 810 whether it has finished executing the edit commands. After the server 810 finishes the edit commands, the DMR 824 then downloads and plays the modified multimedia file again.

It should be noted that in another embodiment, the DMC 822 may also directly send the edit commands to the server 810 without going through the DMR 824, so as to instruct the server 810 to modify the multimedia file accordingly. In addition, the DMC 822 may also directly send an administration command to the server 810 to inquire the server 810 whether it has finished executing the edit commands. In short, the communication operations executed between the DMR 824 and the server 810 under the control of the DMC 822 may also be executed by the DMC 822 itself. However, the executing subject is not limited in the present embodiment.

For example, for editing a picture, the DMC controls the DMR to download the picture from the DMS and activates an edit mode so as to send commands to the DMR. After the edit operations are completed, the DMC produces a set of edit commands and sends the edit commands to the DMS through the DMR (or directly sends the edit commands to the DMS), so as to control the DMS to update data. Eventually, the DMC or the DMR synchronizes the data updated by the DMS.

For rotating a picture, the DMP or the DMC obtains a set of picture information from the DMS, wherein the picture information contains a thumbnail of each picture. Next, the DMP or the DMC receives rotating operations performed by a user on a plurality of pictures and issues rotating commands corresponding to the pictures to the DMS. Finally, after the DMS finishes rotating the pictures, the DMP or the DMC synchronizes the pictures rotated by the DMS.

For converting the format of a video, the DMP issues a file conversion command to the DMS so as to request the DMS to convert the video into a desired format or resolution and generate a converted video file. Accordingly, this video file is included in the multimedia files provided by the DMS and can be selected, downloaded and played by the DMP.

While administrating the authority for opening files, the DMP possesses the authority (account/password) of administrating the DMS. If the user of the DMP does not want to share a specific picture on the DMS with others, the DMP can issue a right administration command to the DMS to instruct the DMS to remove the shared property of the picture. When the user views the picture by using the DMP again, the user will see that the sharing of the picture is cancelled.

In summary, the invention provides a method and a system for editing a multimedia file, wherein edit operations performed by a user on the multimedia file are converted into edit commands recognizable to a server, and the edit commands are sent to the server so as to control the server to modify the multimedia file.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multimedia file edit method, wherein a multimedia file provided by a server is edited and played by a client device, the multimedia file edit method comprising:
downloading and playing the multimedia file provided by the server;
receiving at least one edit operation for modifying the multimedia file;
converting the edit operation into a plurality of edit commands recognizable to the server;
sending the edit commands to the server to request the server to modify the multimedia file accordingly; and
downloading and playing the modified multimedia file from the server again.

2. The multimedia file edit method according to claim 1, wherein before the step of converting the edit operation into the edit commands recognizable to the server, the multimedia file edit method further comprises:
defining an identification code and an edit code of each of the edit commands, wherein the identification code indicates the multimedia file to be edited, and the edit code indicates the edit operation to be executed.

3. The multimedia file edit method according to claim 2, wherein the step of defining the identification code and the edit code of each of the edit commands further comprises:
defining a new file code of each of the edit commands, wherein the new file code indicates whether a new multimedia file is generated to overwrite the original multimedia file after the edit commands are executed.

4. The multimedia file edit method according to claim 1, wherein the edit commands instruct the server to perform resizing, rotating, brightness adjustment, chromatic aberration adjustment, image processing, or image clipping on the multimedia file.

5. The multimedia file edit method according to claim 1, wherein after the step of sending the edit commands to the server to request the server to modify the multimedia file accordingly, the multimedia file edit method further comprises:
sending an administration command to the server to inquire whether the server finishes executing the edit commands, and downloading and playing the modified multimedia file from the server again when the server finishes executing the edit commands.

6. The multimedia file edit method according to claim 1, wherein the step of downloading and playing the multimedia file provided by the server comprises:
controlling a digital media renderer (DMR) to download and play the multimedia file provided by the server by using a digital media controller (DMC) of the client device.

7. The multimedia file edit method according to claim 6, wherein the step of sending the edit commands to the server to request the server to modify the multimedia file accordingly comprises:
controlling the DMR to send the edit commands to the server by using the DMC of the client device, so as to request the server to modify the multimedia file accordingly.

8. The multimedia file edit method according to claim 6, wherein the step of downloading and playing the modified multimedia file from the server again comprises:
controlling the DMR to download and play the modified multimedia file from the server again by using the DMC of the client device.

9. The multimedia file edit method according to claim 1, wherein the server is a digital media server (DMS) of a digital living network alliance (DLNA) system, and the client device is a digital media player (DMP) or a DMC of the DLNA system.

10. A multimedia file edit system, comprising:
a server, adapted to store a plurality of multimedia files and provide one of the multimedia files according to a play request corresponding to the multimedia file; and
a client device, comprising:
a network unit, connected to the server via a network;
a play unit, adapted to send the play request to the server via the network, so as to download and play the multimedia file provided by the server;
an input unit, adapted to receive at least one edit operation for modifying the multimedia file; and
a conversion unit, adapted to convert the edit operation into a plurality of edit commands recognizable to the server, wherein
the edit commands are sent to the server via the network so as to request the server to modify the multimedia file accordingly, and the play unit downloads and plays the modified multimedia file from the server again via the network.

11. The multimedia file edit system according to claim 10, wherein the conversion unit further defines an identification code and an edit code of each of the edit commands, wherein the identification code indicates the multimedia file to be edited, and the edit code indicates the edit operation to be executed.

12. The multimedia file edit system according to claim 11, wherein the conversion unit further defines a new file code of each of the edit commands, wherein the new file code indicates whether to generate a new multimedia file to overwrite the original multimedia file after the edit commands are executed.

13. The multimedia file edit system according to claim 10, wherein the edit commands instruct the server to perform resizing, rotating, brightness adjustment, chromatic aberration adjustment, image processing, or image clipping on the multimedia file.

14. The multimedia file edit system according to claim 10, wherein the play unit further sends an administration command to the server via the network to inquire the server whether the execution of the edit commands is finished, and the play unit further downloads and plays the modified multimedia file from the server again when the server finishes executing the edit commands.

15. The multimedia file edit system according to claim 10, wherein the client device comprises:
a DMR, for playing the multimedia file; and
a DMC, for controlling the DMR to download and play the multimedia file provided by the server.

16. The multimedia file edit system according to claim 15, wherein the DMC further controls the DMR to send the edit commands to the server, so as to request the server to modify the multimedia file accordingly.

17. The multimedia file edit system according to claim 15, wherein the DMC further controls the DMR to download and play the modified multimedia file from the server again.

18. The multimedia file edit system according to claim 10, wherein the server is a DMS in a DLNA system, and the client device is a DMP or a DMC in the DLNA system.
